(19) United States
(12) Patent Application Publication
(10) Pub. No.: US 2017/0225266 A1
(43) Pub. Date: Aug. 10, 2017

(54) Overlay Material For Laser Shock Peening

(71) Applicants: Airbus Operations GmbH, Hamburg (DE); Coventry University, Coventry (GB)

(72) Inventors: Domenico Furfari, Hamburg (DE); Michael Fitzpatrick, Northampton (GB)

(73) Assignees: Airbus Operations GmbH, Hamburg (DE); Coventry University, Coventry (GB)

(21) Appl. No.: 15/422,939

(22) Filed: Feb. 2, 2017

(30) Foreign Application Priority Data
Feb. 4, 2016 (EP) 16 154 216.2

(51) Int. Cl. B23K 26/00; B23K 26/356

(52) U.S. Cl. CPC B23K 26/0069; B23K 26/009; B23K 26/356

(57) ABSTRACT

A solid overlay for laser shock peening is described herein. The solid overlay includes a transparent or translucent material, wherein the solid overlay is structured and adapted to a shape of a surface of a component to be treated by the laser shock peening. The solid overlay is configured to confine a plasma plume generated by laser light.

### FIELD OF THE INVENTION

The invention generally relates to a customised overlay material for plasma confinement for the processing of aircraft components by laser shock peening.

In particular, the invention relates to a solid overlay for laser shock peening, a method for laser shock peening, and an aircraft component processed by laser shock peening.

### BACKGROUND OF THE INVENTION

Laser shock peening is based on the coupling of high energy pulsed laser beams into materials or components whereby the propagation of shock waves is caused and, hence, a near-surface residual compressive stress is generated and material hardening is achieved.

U.S. Pat. No. 4,937,421 describes a laser peening apparatus and method for peening a workpiece utilizing a laser beam. The therein described system includes a foil aligned with a surface of the workpiece to be peened. The therein described foil absorbs energy from the beam thereby the foil is vaporized creating a hot plasma. The plasma creates a shock wave which passes through the foil and peens the workpiece surface.

### BRIEF SUMMARY OF THE INVENTION

An aspect of the present invention is directed to providing an improved laser shock peening process.

According to an embodiment, a solid overlay for laser shock peening is provided, the solid overlay comprising: a transparent or translucent material, wherein the solid overlay is structured and adapted to a shape of a surface of a component to be treated by the laser shock peening.

According to a further embodiment, the present invention relates to a method for laser shock peening, the method comprising the steps of providing a component with a surface to be treated by the laser shock peening; providing a solid overlay on the surface, wherein the solid overlay comprises a transparent or translucent material, wherein the solid overlay is structured and adapted to a shape of the surface; and applying laser light to the component, wherein the laser light is transmitted through the solid overlay and absorbed at the surface, generating a plasma plume.

According to a further embodiment, an aircraft component processed by a method according to the second aspect or according to any implementation of the second aspect is provided.

In other words, for the laser shock peening process, the surface to be treated is covered with a transparent, solid layer, wherein this layer lets the laser beam pass through and provides that the laser beam hits afterwards the surface of the component to be treated, for instance the component is further covered with a protective, ablative layer such as a paint or a tape. The laser beam vaporizes material of the component at the surface or material from the protective or ablative layer and consequently a plasma plume is formed. The transparent or translucent overlay provides that the generated plasma is confined thereby enhancing the deforming effect of the plasma on the surface of the component to be treated.

Without confining the generated plasma plume the high pressure plasma would reflect backwards into the air instead of travelling into the material and would create a high amplitude stress shock wave.

As the stress wave propagates into the material, since it is reflected by the overlay, deformation is caused and thereby residual stress is generated which hardens the material.

Using a solid, transparent or translucent overlay provides the advantage that the laser shock peening process can be used even if electrical systems are adjacent to the surface to be processed.

An aspect of the present invention provides a transparent or a translucent overlay to confine the plasma, wherein the transparent or translucent overlay is to be shaped to follow the contour of the surface of the component to be treated.

The term “the solid overlay is structured and adapted to a shape of a surface of a component” as used in the application may be used to define that a certain shape or two-dimensional or three-dimensional contour of the surface of the component to be treated corresponds to the shape or in the two-dimensional contour or in the three-dimensional contour of the solid overlay. In other words, there may be a threshold distance for a minimal distance between the surface of the component to be treated and the contour of the solid overlay.

The threshold distance may for instance be up to 2 μm, up to 10 μm or up to 100 μm or up to 1000 μm or up to 10 mm or up to 100 mm or up to 20 cm. The thickness of the transparent or the translucent overlay may be for instance without limitation between 2 μm and 25 000 μm or between 5 μm and 7500 μm or between 10 μm and 500 μm.

According to an embodiment, the solid overlay is configured to be producible by additive manufacturing. This advantageously allows synthesizing the solid overlay as a three-dimensional object based on three-dimensional printing, wherein successive layers of material are formed under computer control to create the solid overlay. Any kind of transparent or translucent polymer may be used for the three-dimensional printing process.

According to another embodiment, the solid overlay is configured to be producible by cutting processes. This advantageously allows easily cutting the solid overlay out of a bulk layer structure.

According to another embodiment, the solid overlay may further comprise a surface texture, wherein the surface texture is configured to adapt a pressure pulse transmitted to the surface of the component upon laser shock peening. This advantageously allows further adapting and adjusting the intensity of the surface treatment process. The used laser systems may be high energy, Nd-glass lasers producing pulse energies, for instance without limitation, up to 20 J or up to 40 J or up to 60 J. Pulse duration may be for instance without limitation between 2 ns and 200 μs or between 10 ns and 20 μs or between 20 ns and 100 ns.

According to another embodiment, the solid overlay is configured to confine a plasma plume generated by the laser light. This advantageously allows further controlling the laser shock peening process.

According to another embodiment, the solid overlay is configured to prevent backward reflections of the plasma plume with respect to the surface of the component. This advantageously allows further improving the laser shock peening process.

According to another embodiment, the solid overlay is configured to be coupled to the surface of the component. For instance, the solid overlay is a metallic layer and the solid overlay is coupled to the surface by an adjoining process.

According to another embodiment, the solid overlay is configured to be coupled to the surface of the component by a protective layer or by an ablative layer. The protective layer or the ablative layer may be a tape, for instance an adhesive tape.

In general, the method describes a processing method for processing components used for aircraft. The method may also be used for processing components used for non-aircraft applications, for instance, components for marine vehicles, components for land vehicles, or for stationary machines or any further components.

### BRIEF DESCRIPTION OF THE DRAWINGS

FIG. 1 schematically shows an aircraft structure near to electrical systems inside cockpit areas according to an embodiment.

FIG. 2 schematically shows a perspective view of a component to be treated by laser shock peening according to an embodiment

FIG. 3 schematically shows a solid overlay for laser shock peening and a component to be treated by the laser shock peening according to an embodiment.

FIG. 4 schematically shows a solid overlay for laser shock peening and a component to be treated by the laser shock peening according to an embodiment.

FIG. 5 schematically shows a flow-chart diagram of a method for laser shock peening according to an embodiment.

### DETAILED DESCRIPTION

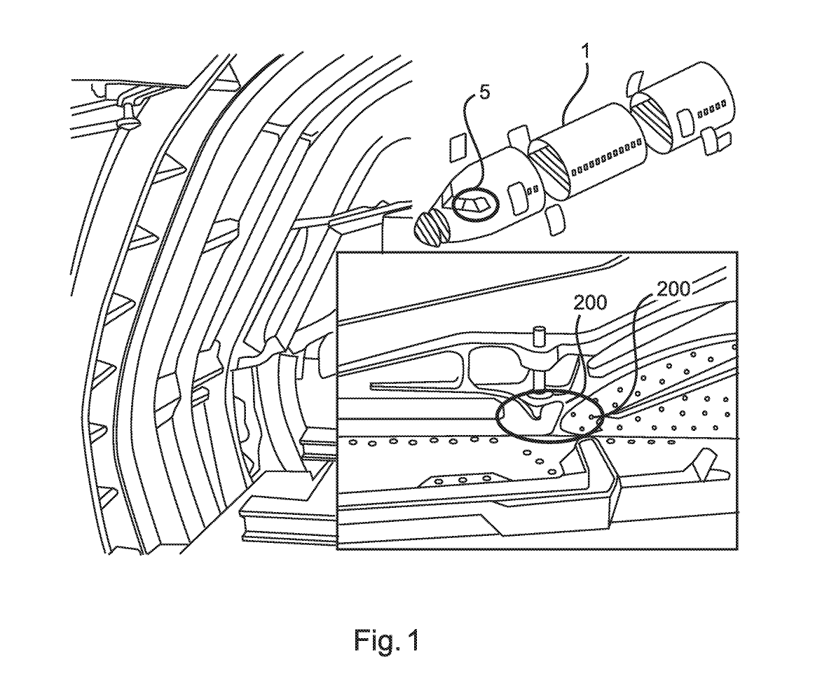

FIG. 1 shows an aircraft structure near to electrical systems inside cockpit areas according to an embodiment.

Using a transparent or translucent overlay for the laser shock peening technique provides that the laser shock peening may be applied more effectively in aircraft manufacture.

Using a transparent or translucent overlay allows removing the water layer that is currently applied ubiquitously in laser peening manufacturing. The water layer is usually applied by a nozzle, with the water running down the workpiece under gravity.

With three-dimensional, 3D, -printing or machining techniques, combined with detailed 3D-surface profilometry, a solid overlay material may be fabricated that would be a perfect match to any surface.

The overlay may be formed with a textured surface in order to customise the pressure pulse profile into the material.

FIG. 1 shows the assembly of structural components of the aircraft fuselage 1 as the aircraft's main body section. The cockpit 5 may comprise components 200, which are located adjacent to electrical systems of the aircraft.

Using a solid, transparent or translucent overlay 100 provides the advantage that the laser shock peening process can be used even if electrical systems are adjacent to the surface to be processed.

The term “transparent” as used in the application may refer to a physical property of allowing light to pass through the material without being scattered or absorbed. In other words, at least a certain threshold value, for instance more than 95% of the incoming light may be allowed to pass through the material without being absorbed or scattered by the material.

The term “translucent” as used in the application may refer to a physical property of allowing light to pass through the material without being absorbed. In other words, at least a certain threshold value, for instance more than 95% of the incoming light may be allowed to pass through the material without being absorbed by the material.

In other words, a translucent medium allows the transport of light while a transparent medium not only allows the transport of light but allows for image formation.

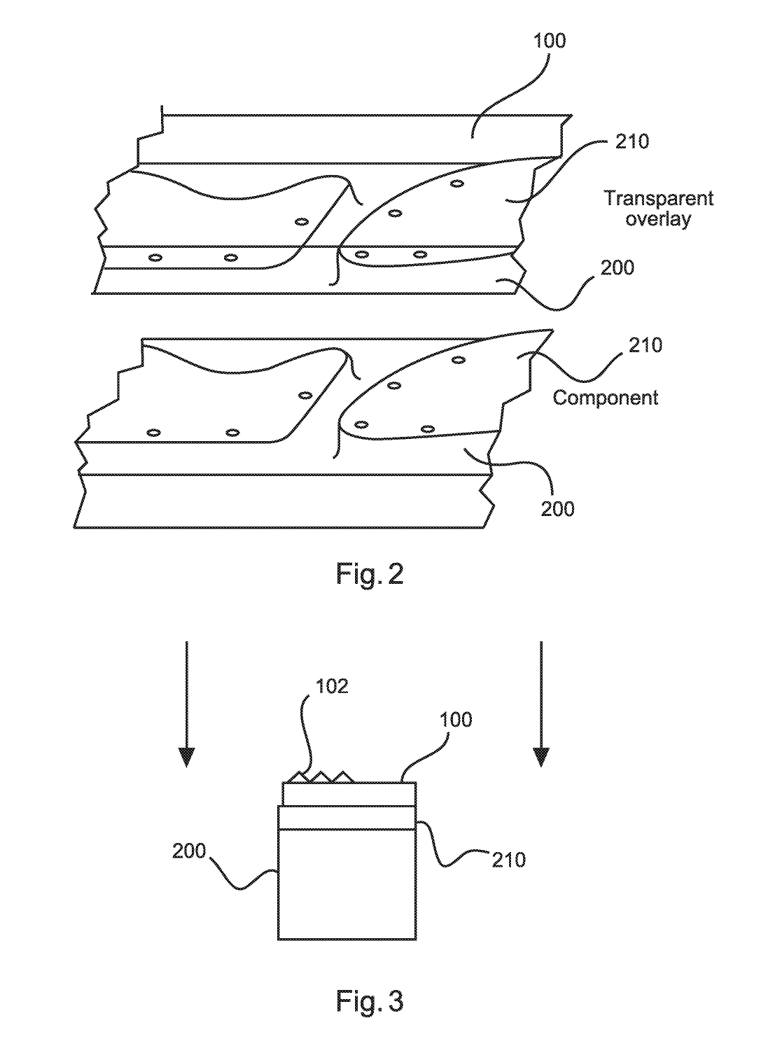

FIG. 2 schematically shows a perspective view of a component to be treated by laser shock peening according to an embodiment.

A solid overlay 100 for laser shock peening may be deposited on top of a surface 210 of a component 200 to be treated by the laser shock peening. Without the solid overlay 100, the plasma plume 230 would not be confined and would not shift from the surface and, lowering the peak pressure.

The laser shock peening, LSP, method may be based on the coupling of high energy pulsed laser beams into materials or components 200, generating a propagation of shock waves and, hence, of near-surface residual compressive stresses and hardening of the surface 210 or of surface-near parts—up to several mm of structural depth depending on the energy applied—of the bulk material of the component 200.

The laser used for the laser shock peening may for instance be a pulsed Nd:YAG laser or a laser with 1054 nm wavelength and 2-20 ns laser pulse length.

FIG. 3 schematically shows a solid overlay for laser shock peening and a component to be treated by the laser shock peening according to an embodiment.

A solid overlay 100 for laser shock peening may comprise a transparent or translucent material, wherein the solid overlay 100 is structured and adapted to a shape 220 of a surface 210 of a component 200 to be treated by the laser shock peening.

The solid overlay 100 may be configured to be producible by additive manufacturing, producible by liquid spraying, or by cutting processes.

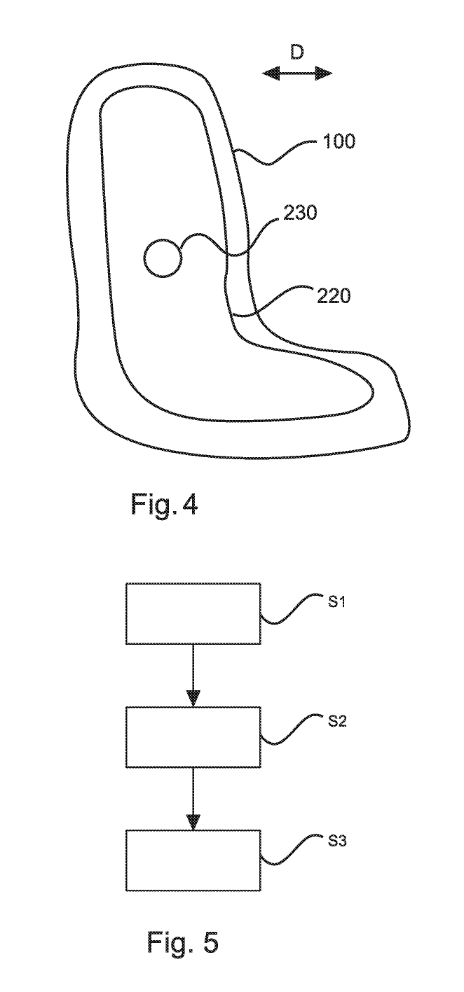

FIG. 4 schematically shows a solid overlay for laser shock peening and a component to be treated by the laser shock peening according to an embodiment.

The component 200, or the shape 220 of the component, may be separated from the solid overlay 100 by a threshold distance D.

The threshold distance D may for instance be up to 2 μm, up to 10 μm or up to 100 μm or up to 1000 μm or up to 10 mm or up to 100 mm or up to 20 cm. The thickness of the transparent or the translucent overlay may be for instance without limitation between 2 μm and 25 000 μm or between 5μm and 7500 μm or between 10 μm and 500 μm.

FIG. 5 schematically shows a flow-chart diagram of a method for laser shock peening according to an embodiment.

The method may comprise the following steps of:

As a first step of the method, providing S1 a component 200 with a surface 210 to be treated by the laser shock peening may be performed.

As a second step of the method, providing S2 a solid overlay 100 on the surface 210 may be performed, wherein the solid overlay 100 comprises a transparent or translucent material, wherein the solid overlay 100 is structured and adapted to a shape 220 of the surface 210.

As a third step of the method, applying S3 laser light to the component 200 may be conducted, wherein the laser light is transmitted through the solid overlay 100 and absorbed at the surface 210, generating a plasma plume 230.

While the invention has been illustrated and described in detail in the drawings and the foregoing description, such illustration and description are to be considered illustrative and exemplary and not restrictive; the invention is not limited to the disclosed embodiments.

Other variations to the disclosed embodiments can be understood and effected by those skilled in the art and practicing the claimed invention, from a study of the drawings, the disclosure, and the appended clams. In the claims the term “comprising” does not exclude other elements, and the indefinite article “a” or “an” does not exclude a plurality.

The mere fact that certain measures are recited in mutually different claims does not indicate that a combination of these measures cannot be used to advantage.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A solid overlay for laser shock peening, the solid overlay comprising:
a transparent or translucent material, wherein the solid overlay is structured and adapted to a shape of a surface of a component to be treated by the laser shock peening.

2. The solid overlay according to claim 1, wherein the solid overlay is configured to be producible by additive manufacturing.

3. The solid overlay according to claim 1, wherein the solid overlay is configured to be producible by cutting processes.

4. The solid overlay according to claim 1, further comprising a surface texture, configured to adapt a pressure pulse transmitted to the surface of the component upon laser shock peening.

5. The solid overlay according to claim 1, wherein the solid overlay is configured to confine a plasma plume generated by laser light.

6. The solid overlay according to claim 5, wherein the solid overlay is configured to prevent backward reflections of the plasma plume with respect to the surface of the component.

7. The solid overlay according to claim 1, wherein the solid overlay is configured to be coupled to the surface of the component.

8. The solid overlay according to claim 7, wherein the solid overlay is configured to be coupled to the surface of the component by a protective layer or by a ablative layer.

9. A method for laser shock peening, the method comprising:
providing a component with a surface to be treated by the laser shock peening;
providing a solid overlay on the surface, wherein the solid overlay comprises a transparent or translucent material, wherein the solid overlay is structured and adapted to a shape of the surface; and
applying laser light to the component, wherein the laser light is transmitted through the solid overlay and absorbed at the surface, generating a plasma plume.

10. The method according to claim 9, wherein the solid overlay is produced by additive manufacturing.

11. The method according to claim 9, wherein the solid overlay is produced by cutting processes.

12. The method according to claim 9, wherein a surface texture of the solid overlay adapts a pressure pulse transmitted to the surface of the component upon laser shock peening.

13. An aircraft component processed by a method for laser shock peening, the method comprising:
providing a component with a surface to be treated by the laser shock peening;
providing a solid overlay on the surface, wherein the solid overlay comprises a transparent or translucent material, wherein the solid overlay is structured and adapted to a shape of the surface; and
applying laser light to the component, wherein the laser light is transmitted through the solid overlay and absorbed at the surface, generating a plasma plume.
